(19) United States
(12) Patent Application Publication
(10) Pub. No.: US 2005/0171838 A1
(43) Pub. Date: Aug. 4, 2005

(54) Internet-based and tangible referral system

(76) Inventor: Charles Eglinton, Farmington Hills, MI (US)

Correspondence Address: JEFFREY FURR, 253 N. MAIN STREET, JOHNSTOWN, OH, 43031, US

(21) Appl. No.: 10/708,029

(22) Filed: Feb. 3, 2004

(51) Int. Cl. G06F 17/60

(52) U.S. Cl. 705/14

(57) ABSTRACT

The invention is an Internet-based and tangible referral system that enables individuals and other business entities (“Affiliates”) to market products, in return for compensation which is paid as a result from any sale or sales lead that is induced by that Affiliate. A uniquely modified version of the printed web page or electronically transferred document, which explicitly or non-explicitly identifies the relationship or the offer, is instrumental to the tracking, fulfillment of commissions paid to the Affiliate by the Advertiser.

### BACKGROUND OF INVENTION

1. Field of the Invention

This invention relates to the art of Internet-based and tangible referral system and more specifically the use of unique identifiers for this purpose.

2. Description of Prior Art M

More and more commerce is moving to the Internet. This movement creates opportunities and problems. The Internet is a great tool for visual information and advertising, but this advertising is not set up to be in a printed format or set up for print or internet related referrals.

The World Wide Web is currently a subject of intense and rapidly growing interest. The World Wide Web is composed of interconnected data sources that are accessible to computer users through data-communication networks such as the Internet. The data available on the World Wide Web has been assembled by private individuals, commercial companies, government agencies, and special interest organizations. Much of this assembled information is organized into Web pages. A Web site is a collection of Web pages (and possibly other data which, together with Web pages, are generically referred to as Web components) offered by a sponsoring entity, herein referred to as the site owner.

Large Web sites are typically organized hierarchically. For example, corporate Web sites often consist of smaller Web sites, each providing information about a business unit of the parent company.

The Web site itself resides on one or more server hosts. Web components stored on the server host are offered to users of the World Wide Web through a software program known as a Web server. A network user uploads or downloads data from a Web site through a browser, a software program running on the client host. The browser establishes contact with the Web server and issues a request for data stored on the server host. This results in data from the server host being downloaded into the browser. This data is typically a HyperText document specifying information required by the browser to display the Web page (i.e., formatting information specifying the structure of the page, or URLs of images that are to be placed on the page), embedded client software programs which run inside the browser (e.g., Java bytecode), and other content to be downloaded to the client computer or displayable through client software programs that add to the browser's functionality (sometimes referred to as “browser plug-ins”).

Currently, Web pages are typically defined using HyperText Markup Language (“HTML”). HTML provides a standard set of tags that define how a Web page is to be displayed. When a user indicates to the browser to display a Web page, the browser sends a request to the server computer system to transfer to the client computer system an HTML document that defines the Web page. When the requested HTML document is received by the client computer system, the browser displays the Web page as defined by the HTML document. The HTML document contains various tags that control the displaying of text, graphics, controls, and other features. The HTML document may contain URLs of other Web pages available on that server computer system or other server computer systems.

With the rapid growth of computer networking and requests for information from one computer to the next e.g. the Internet, it has become common practice for a provider of information (a “Server”) to provide each specific requester of information (a “Client”), with an electronic “token” (commonly referred to as a “Cookie”) for the purpose of “recognizing” the client and/or providing some pre-determined and pre-programmed level of customization at the discretion of the information provider.

Prior Art

U.S. Pat. No. 6,457,005 by Torrey and issued on Sep. 24, 2002 is for a “Method and system for referral management.” It discloses the solicitation and management of referrals facilitated by methods that record in a database the descriptions of opportunities and the terms under which referral fees will be paid to parties that refer resources for consideration. U.S. Pat. No. 6,314,404 by Good, et al. and issued on Nov. 6, 2001 is for a “Method and apparatus for managing real estate brokerage referrals.” It discloses a method for managing real estate brokerage referrals in which the referrals are made by a broker for residential real estate. U.S. Pat. No. 6,029,141 by Bezos, et al. and issued on Feb. 22, 2000 is for an “Internet-based customer referral system.” It discloses an Internet-based referral system that enables individuals and other business entities (“associates”) to market products, in return for compensation, that are sold from a merchant's Web site. U.S. Pat. No. 6,546,418 by Schena, et al. and issued on Apr. 8, 2003 is for a “Method for managing printed medium activated revenue sharing domain name system schemas.” It discloses a method for bridging the gap between the virtual multimedia-based Internet world and the physical world of tangible object media, such as advertising print media.

U.S. Pat. No. 6,334,111 by Carrott and issued on Dec. 25, 2001 is for a “Method for allocating commissions over the internet using tags.” It discloses a method and structure for allocating commissions for sales made over the Internet including providing a link to a merchant site, attaching a tag to potential customers who select the link (where the tag identifies an association between the potential customers and a salesperson who provided the link), and allocating the commissions for purchases made by the potential customers based upon the tag. U.S. Pat. No. 5,537,314 by Kanter and issued on Jul. 16, 1996 is for a “Referral recognition system for an incentive award program.” It discloses a credit accumulation and accessing system for a plurality of sponsoring companies and participants having at each sponsoring company location a common bus, which communicates with participant data input, performance data input, computer processing, memory, an award output device, and an input/output device.

These systems and prior patents do not disclose and use print media from the websites to track referrals.

The need for a better method for the printing and tracking of advertisement from the Internet, that is faster, inexpensive, and easy to use shows that there is still room for improvement within the art.

### SUMMARY OF INVENTION

The object of the present invention is to provide a merger of Internet and Advertising Print Medium.

The current invention is a method for bridging the gap between the virtual multimedia-based Internet world and the physical world of tangible object media, such as print advertising. More particularly, a method for multimedia-based Internet Advertisers to expand the promotion of their products and web pages by encouraging Affiliates to post uniquely identified printed versions of the virtual advertising to be posted or otherwise physically distributed in the tangible world.

The current invention is an internet-based customer referral system software to interactively create, distribute, and uniquely Identified Tangible Print Advertising from Internet Web Pages and to track the activity of affiliates, sub-affiliates and customers.

The current invention utilizes the Internet. The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system. The remote client computer system can then receive the graphic information via electronic transmittal or display the Web pages. Each resource (e.g., computer, file or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that affects the requesting of Web pages and the displaying of Web pages.

The process is more efficient, effective, accurate and functional than the current art.

Glossary of Terms

Affiliate/Client: person or business who markets the Advertiser's products in return for monetary payment, product credit or discounts, or other compensation Advertiser/Publisher: person or business with the items or products to sell.

Advertiser Media: includes the web page or other prospective Internet based information that is distributed by the Advertiser via modem, and ultimately printed and distributed by the Affiliate.

Browser: a software program that runs on a client host and is used to request Web pages and other data from server hosts. This data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Embedded client software programs: software programs that comprise part of a Web site and that get downloaded into, and executed by, the browser.

Clip: a video stream that contains images and possible sound.

Cookies: data blocks that are transmitted to a client browser by a web site.

Hit: the event of a browser requesting a single Web component.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

Logfile: a file residing on the Web site in which the Web server logs information about browsers requesting Web components. The logfile typically contains one line per hit.

Offline Affiliate Clearinghouse: the service at which accounts are settled. An Advertiser makes payment to clearinghouse and the Affiliate receives payment from the clearinghouse. Any or all of the participants in the service may pay fees to the clearinghouse. Accounts are settled by the clearinghouse and where the Advertisers make payment and where the Affiliate proposed services to make any web site into print-ready flyer, poster, or other printable advertising media. The service will use a method to place a Unique Identifier Code for each enrolled Advertiser/Publisher or product for each enrolled web page.

Unique Identifier Code: an alphanumeric code that identifies the Affiliate/Client, the Advertiser/Publisher, the particular offer, or any other information related to the relationship of these.

Pageview: the event of a browser downloading some or all of the Web components that make up a Web page and displaying the Web page. A pageview often consists of several hits.

Referral page: the URL of the Web page containing the HyperText link that led a visitor to the data currently being viewed. In most commercial browsers, the BACK button returns the visitor to this referral page.

Server host: a computer on the Internet that hands out Web pages through a Web server program.

Tangible Media: Includes media that can be seen and held in the tangible world. For example, tangible media includes printed pages of all sizes including flyers, posters, coupons and business cards.

Uploader: someone who wants to upload a video clip or image.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Viewer: someone who wants to view the video image or clip.

“virtualFlyer or virtualPoster: a web page or graphic download that was created on demand which contains a unique Identifier code that Identifies the Sub-Affiliate and or Affiliate that will be entitled to compensation or other consideration. Affiliate or Sub-affiliate will print the virtual poster to create tangible print media. The Unique Identifier Code label may but is limited to, “discount code” or “Special Offer Code” Visit: a series of requests to a fixed Web server by a single person (through a browser), occurring contiguously in time.

Visitor: a person operating a browser and, through it, visiting a Web site.

Web component: a basic data building block that makes up a Web page. A Web component may contain text, HyperText, images, embedded client software programs, or other data displayable by a browser (such as, for example, QuickTime videos).

Web designer: a person, typically one skilled in graphical design, who has charge of designing Web pages.

Web master: the (typically, technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF DRAWINGS

Without restricting the full scope of this invention, the preferred form of this invention is illustrated in the following drawings:

FIG. 1 shows an overview of how a User accesses the system through the Internet;

FIG. 2 shows the user accessing a rental web page;

FIG. 3 shows a printed screen and tabs printed from a website;

FIG. 4 displays a tab with the Unique Identifier;

FIG. 5 displays a card print screen;

FIG. 6 displays a card print with the Unique Identifier;

FIG. 7 displays a flowchart of the Unique Identifier process;

FIG. 8 displays the referral system;

FIG. 9 display a flowchart on the referral system; and

FIG. 10 displays the clearinghouse function.

### DETAILED DESCRIPTION

The current invention is a system and method for providing an Internet-based customer referral system software to interactively create, track, and reconcile uniquely Identified Tangible Print Advertising from Internet Web Pages and from computer file downloads.

The current invention is a method for bridging the gap between the virtual multimedia-based Internet world and the physical world of tangible object media, such as print advertising. More particularly, a method for multimedia-based Internet Advertisers to expand the promotion of their products and web pages by encouraging Affiliates to distribute identified printed versions of the virtual advertising to be posted or otherwise physically distributed in the tangible world.

The types of tangible media covered by the current invention would include but not be limited to printed page, posters, business cards, banners, coupons and other printed media.

The current invention is an internet-based customer referral system software to interactively create, distribute, and uniquely Identified Tangible Print Advertising from Internet Web Pages and to track the activity of affiliates, sub-affiliates and customers The current invention utilizes the Internet. The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system. The remote client computer system can then receive the file containing the Uniquely Identified print media or display the Web pages. Each resource (e.g., computer or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that affects the requesting of Web pages and the displaying of Web pages.

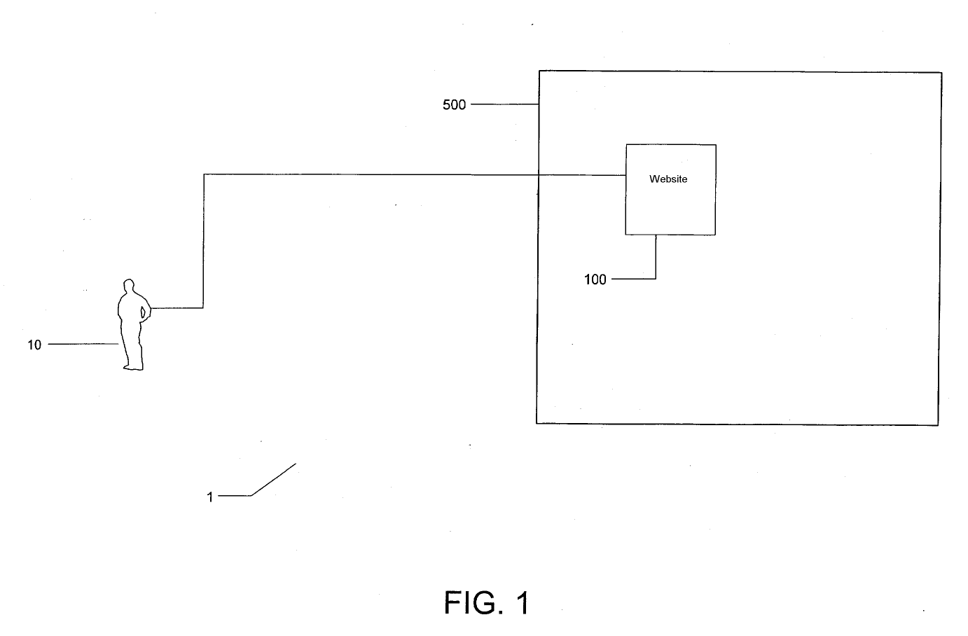

FIG. 1 illustrates a functional diagram of a computer network for World Wide Web access to the system 1 from a plurality of customer/Users 10 to the web site 100. Accessing the web site 100 can be accomplished directly through a communication means such as a local Internet Service Provider, often referred to as ISPs, or through an on-line service provider like CompuServe, Prodigy, American Online, etc.

The Users 10 contact the web site 100 using an informational processing system capable of running an HTML compliant Web browser such as Microsoft's Internet Explorer, Netscape Navigator, Lynx and Mosaic. A typical system that is used is a personal computer with an operating system such as Windows 95, 98, 2000, XP or ME or Linus, running a Web browser. The exact hardware configuration of computer used by the Users 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

Advertiser Media includes the web page or other prospective Internet based information that is distributed by the Advertiser via modem or other connection means such as cable or a T1 line, and ultimately printed and distributed by the Affiliate. An Affiliate or Client is the person or business who markets the Advertiser's products.

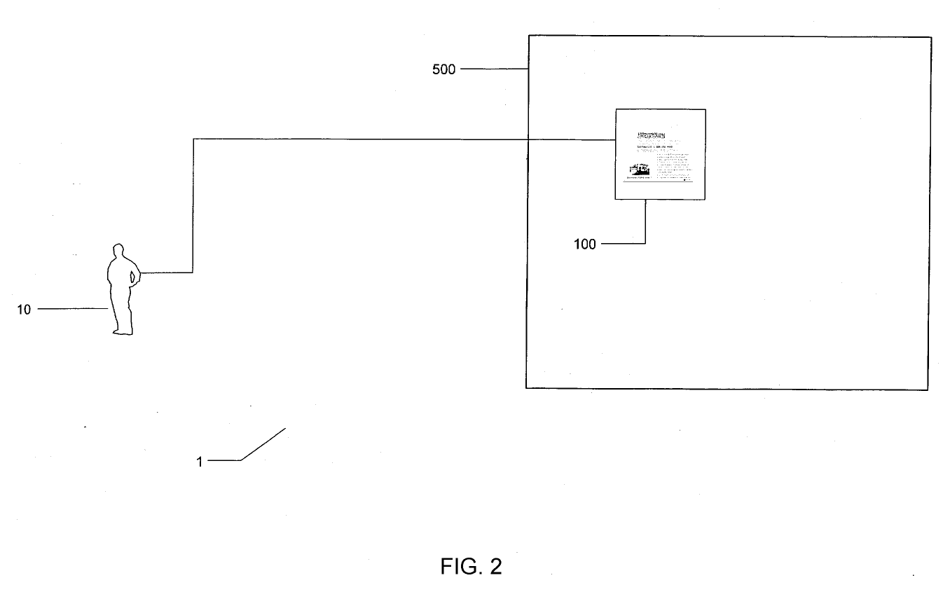

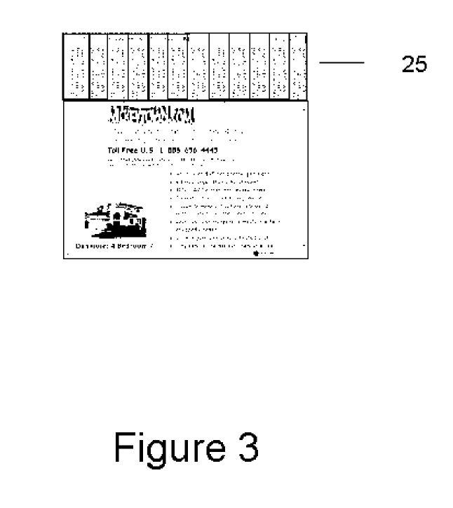

As shown in FIG. 2, the Users 10 connects to a Web site 100 that promotes rental vacation property. This web site would have some type of advisement or information that would interest the User 10. When the user selects the property that interested them they will print out the selected property. This will result in a tangible print media delivery. This will result in a tangible print media delivery. As shown in FIG. 3, this can be in the form of tabs 25 which can be separated by scissors but remain attached to the tangible print media.

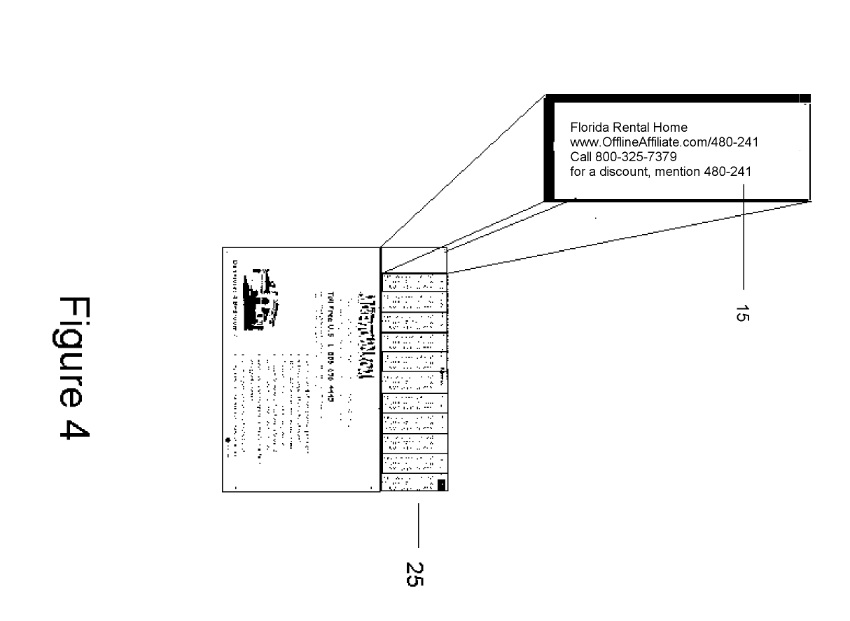

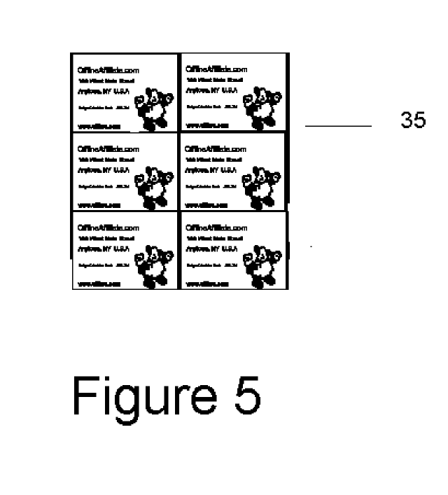

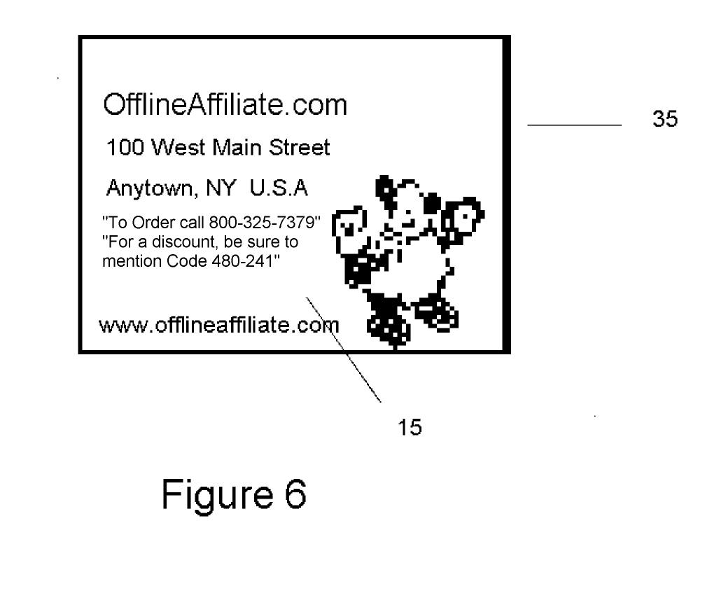

The tangible print media is created by the system” s 1 software. The Tangible Print Media consists of Advertiser's Print Media dynamically merged with a code 15 or other information that will identify the Affiliate who will place the advertising print media in the tangible world as shown in FIG. 4. Media types include: Uniquely Identified Business Cards 35; Uniquely Identified Flyers and Uniquely Identified Posters of any size. Business cards 35 are displayed in FIG. 5 with a detailed view of the unique identifier code 15 in FIG. 6. The user 10 can then print out the tangible print media using any type of printing means such as a laser or inkjet printer that is attached to their computer or a LAN or network.

The Unique Identifier Code 15 is generated by on-line and/or offline software to combine Advertiser information and Coded Affiliate information to create uniquely identified advertising media that is delivered to the Affiliate electronically. This software is loaded on a memory means such as a hard drive or RAM.

The system 1 maintains multiple online databases including Advertiser and Affiliate contact information, commission offers, and commission account reconciliation. The system 1 educates Advertisers and Affiliates regarding successful advertising campaigns using tangible printed advertisement delivered electronically, printed and placed by Affiliates.

In the preferred embodiment, the methods of delivering uniquely identified print advertising are not limited to just a printer, and can include, but are not limited to, Internet Browser, electronic mail, electronic file transfer, traditional mail, and other tangible and electronic methods of delivery. Advertiser fulfills order and/or contacts prospective customer as a result of Tangible Print Advertising. The modification of the media to produce the uniquely identified print advertising associate information is accomplished by having print media offered by the advertiser modified automatically by using Perl, ASP, Javascript or another computer programming language at the moment the media is displayed on the user's computer.

In alternative embodiments, the modification can be done by having the print media offered by the advertiser be modified manually. This includes, but is not limited to, the modification of merchant information using a software-editing program. The prospective tangible print media may also be modified by using overlays that replace designated or undesignated information that is displayed on the merchant's web page.

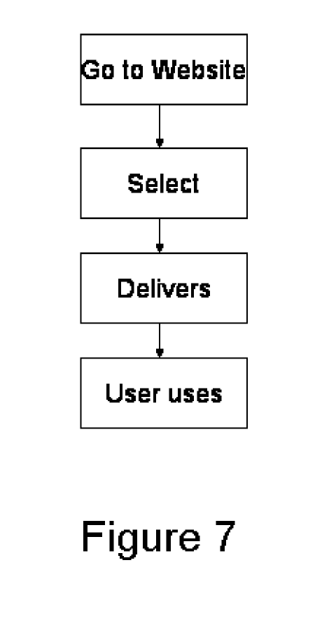

As shown in FIG. 7, the system 1 works in the following manner: The User 10 goes to a particular web site 100 in the Internet 500. After selecting what the User 10 is interested in the User 10 selects the Tangible Print Media option. The system delivers the tangible print media in the User's 10 desired format. The user 10 uses the tangible print media.

Uniquely Identified Business Cards are created by system 1 software that dynamically creates perfectly formatted business cards that are displayed on the User's 10 computer browser or otherwise sent to the User 10. The web site 100 may print then distribute the uniquely identified business cards.

Uniquely Identified Tabbed Flyers are created by system 1 software that dynamically creates tabbed flyers from preexisting Internet Web Pages. The system 1 uses existing browser frames ability with proprietary methods of creating graphical text to create uniquely identified tabbed advertising media. The User 10 may print then distribute or conspicuously post the uniquely identified tabbed business flyers. The User 10 or prospective customers can remove the paper tabs 25 from the top of the flyers to retain contact information for the Advertiser 130.

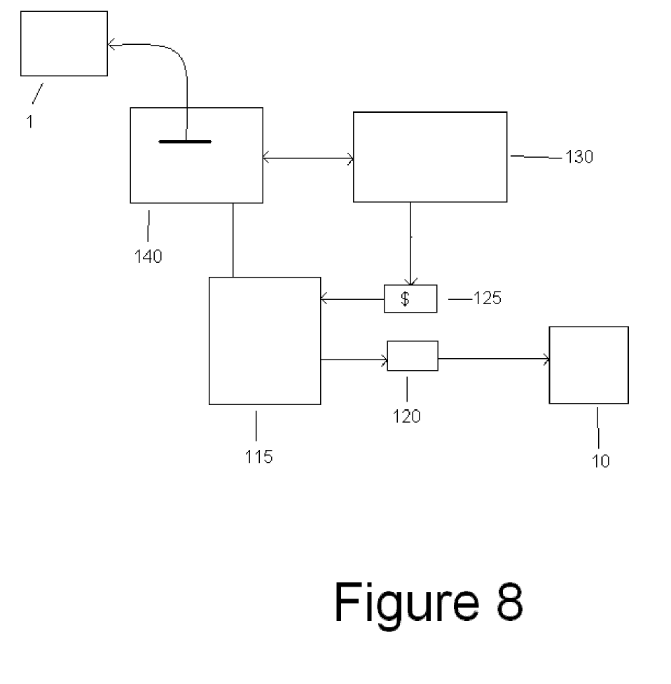

Disclosed in FIG. 8, the system 1 is an Internet-based and tangible referral system that enables individuals and other business entities, Affiliates 115, to market products 120, in return for a commission 125, referral fee, or other compensation which is paid as a result from any sale that is induced by that Affiliate 115. A uniquely modified version of the printed web page, which explicitly or non-explicitly identifies the relationship or the offer, is instrumental to the tracking, fulfillment of commissions paid to the Affiliate 115 by the Advertiser 130. The system 1 has tier-1 and tier-2 affiliates. Tier-1 affiliates have websites and promote services and products 120 to their viewers. Tier-2 affiliates are the people who volunteer to print and distribute the print media.

The system 1 is a viral mechanism for attracting advertisers and affiliates. The Tier-1 Affiliates 115 may or may not be Advertisers 130. They will have a link on their website the purpose may be to sell a product 120 through Tier-2 Affiliates 115, or the link may just be a method to Tier-2 affiliates 115 by referring them to the Offline Affiliate service.

Depending on the link that the Tier-2 affiliate 115 follows from the Tier-1 affiliate's web site, the tier-2 affiliate may see a specific offer for an advertiser 130, or they may see catalog of many Offline Affiliate offers may be displayed.

The Tier-1 affiliate 115 will get a portion of the commissions 120 or referral fees that are paid to the Tier-2 affiliate 115 as the result of sales and leads generated from Tier-2 affiliate's distribution of the Uniquely Identified Print media. The job of the tier-1 affiliate 115 is to use Internet web pages to recruit tier-2 affiliates 115 who will distribute uniquely identified print media in the tangible world.

The system 1 can be used to market directly to Tier-2 affiliates, without the use of Tier-1 Affiliates.

When a potential customer completes a sale or information is provided to an Advertiser as a result of Tier-1 or Tier-2 affiliate 115 advertising, advertiser pays a fee to the Clearinghouse is credited to referring Tier-1 and Tier-2 Affiliates.

The catalog document includes a hypertextual “referral link” that allows a Tier-1 Affiliate 10 (“customer”) to link to the Advertiser's site 140 and purchase the product 145. When a user 10 selects a referral link, the user's computer transmits unique IDs 15 of the selected product 145 and of the Affiliate 115 to the Advertiser's site 140, allowing the Advertiser 130 to identify the product 145 and the referring Affiliate 115. If the user 10 subsequently purchases the product 145 from the Advertiser's site compensation 125 is automatically credited to an account of the referring Tier-1 and Tier-2 Affiliates 115.

The system 1 includes automated registration system 150, or software, that operates on the Advertiser's Web site 140 or at a central website to allow entities to register as Affiliates 115. Affiliates 115 may also register via mail fax or any other method of correspondence. Following registration, the Affiliate 115 selects the products 145 or websites for which the Affiliate 115 would like to earn compensation 125.

Operation

The prospective Affiliate 115 discovers via a hyperlink on the Advertiser's web page 140. The advertiser's web page 140 has a hyperlink that leads to the system 1 where the Affiliate 115 may set up an account by providing contact information, telephone numbers, address, and tax withholding information. The system 1 will provide a searchable database of Advertisers 130 that describes their item(s) for sale and the commission 125, pay per lead, or other compensation to be paid to the Affiliate 115. When selecting a Advertiser 130, the Affiliate 115 can click a link that will produce a custom web page or formatted print media file for that includes a special contact telephone number, email address, or web site. The incentive for the Advertiser 130 is distribution and additional exposure of virtual advertising materials via tangible print advertising as facilitated by Affiliates 115 that print the tangible print media and post it in public and private locations in the tangible world. The incentive for the Affiliate 115 is a pay-for-performance monetary commission, pay-per-lead other compensation 125 as established by the Advertiser 130. The incentive for the user is that they may not have had previous knowledge of the offer or there may be a discount or special deal Affiliated with the Unique Identifier Code 15.

The system 1 uses a variety of unique techniques including but not limited to Web Browser frames, Javascript routines that place Affiliate 115 contact information on the web page before or while it is printed by the Affiliate 115.

It is expected that many Advertisers 130 and Affiliates 115 will be attracted to this relationship because of proprietary computer and software technology that simplifies the technical aspects of beginning the relationship, providing offers, tracking activities, and tracking commissions.

The system 1 uses a variety of unique techniques including but not limited to: On-demand custom graphics embedded in the web page; Custom frames added without the need for original web page modification; and Unique graphically composed text printed vertically for printed tear-off tags 25.

As an example on how the system 1 works, the Advertiser 130 uses an Internet web page to rent a short-term rental home or long-term rental home. Previous rental clients use system 1 to print a customized version of the web page that they give to friends and relatives. When friends and relatives contact the affiliate 115 or advertiser 130 via telephone, fax, email, or Internet, they refer to the “Offer Code” for a customer discount and to identify the Affiliate 115 to whom compensation 125 or referral feebe paid.

Another example, the Advertiser 130 uses an Internet Web Page to sell cosmetics. An office worker uses the system 1 to print a custom version of the webpage with special contact information and an Unique Identifier Code 15. When coworkers (customers) purchase items using the special phone number and Unique Identifier Code the Affiliate 115 will receive compensation 125.

An additional example, the Advertiser 130 is a seller of an Automobile at eBay or other online auction venue. The seller can use system 1 to print custom versions of the Automobile listing which use the system's 1 contact sources. The affiliate 115 becomes an answering service to take calls for the item being sold. The affiliate 115 takes messages and sends them via email, phone, fax (or other means) to the Advertiser 130.

A final example, the Advertiser 130 is a seller of Cloth Gloves. A factory worker as an Affiliate 115 prints a tangible advertisement and places it on a company bulletin board. The workers call the affiliate 115 to leave a contact phone number, a message is sent to the Advertiser 130 who contacts prospective customers to close the deal. Compensation is paid to the Factory worker Affiliate 115 who posted the tangible advertisement.

The advertiser 130 may choose to compensate affiliates 115 by “pay per lead” for example; an advertiser 130 may pay for delivery of a prospective customer—without the customer actually buying anything. For example, a manufacturer may pay $1 per qualified buyer that is sent as a result of the tangible print advertising. So, revenue can be either pure commission, “pay per lead” or a combination of both.

Buyer referrals will be a result of tangible print media. The Unique Identifier Code 15 information may include a variety of contact details so that an order may be placed. Ideally, the order should be placed through a clearinghouse then forwarded to the Advertiser. This is to prevent avoidance of fees and commissions 125 by the Advertiser 130.

In the preferred embodiment, the possible methods for order fulfillment by the buyer as a result of viewing the tangible print media include telephone, postal mail, Internet, e-mail, and fax.

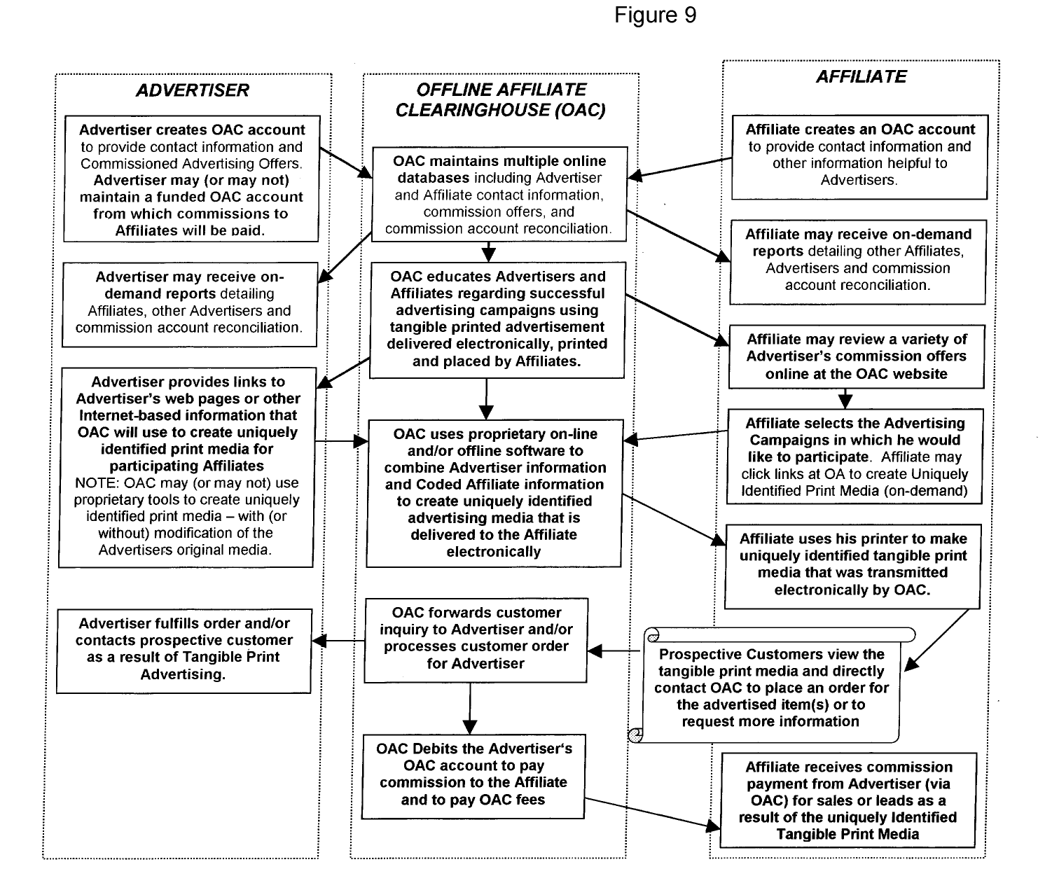

FIG. 9 displays a flowchart on how the system 1 works. The Advertiser 130 creates an account to provide contact information and Commissioned Advertising Offers. Advertiser 130 may maintain a funded account from which commissions 125 to Affiliates 115 will be paid. The Advertiser 130 may receive on-demand reports detailing Affiliates 115, other Advertisers and commission account reconciliation. The Advertiser 130 provides links to Advertiser's web pages 140 or other Internet-based information that the system 1 will use to create uniquely identified print media for participating Affiliates. The system 1 may use tools to create uniquely identified print media with or without modification of the Advertisers original media. The Advertiser 130 fulfills order and/or contacts prospective customer as a result of Tangible Print Advertising.

The system 1 maintains multiple online databases on a memory means such as a magnetic or optical storage system including Advertiser 130 and Affiliate 115 contact information, commission offers, and commission account reconciliation. The system 1 educates Advertisers 130 and Affiliates 115 regarding successful advertising campaigns using tangible printed advertisement delivered electronically, printed and placed by Affiliates 115. The system 1 user's on-line and offline software to combine Advertiser information and Coded Affiliate information to create uniquely identified advertising media that is delivered to the Affiliate 115 electronically. The system 1 forwards customer inquiry to the Advertiser 130 and/or processes customer order for Advertiser 130. The system 1 debits the Advertiser's account to pay commission to the Affiliate 115 and to pay system 1 fees.

The Affiliate 115 creates an account to provide contact information and other information helpful to Advertisers 130. The Affiliate 115 may receive on-demand reports detailing other Affiliates, Advertisers and commission account reconciliation. The Affiliate 115 may review a variety of Advertiser's commission offers online at the system's website. The Affiliate 115 selects the Advertising Campaigns in which they would like to participate. The Affiliate 115 may click links at the system 1 to create Uniquely Identified Print Media on-demand. The Affiliate 115 uses their printer to make uniquely identified tangible print media that was transmitted electronically by the system 1. The prospective Customers view the tangible print media and directly contact the Advertiser or the Offline Affiliate Clearinghouse 115 to place an order for the advertised item(s) or to request more information.

The Affiliate 115 receives commission 125 payment from Advertiser 130 for sales or leads as a result of the uniquely Identified Tangible Print Media. The system 1 provides for Real-time tracking of Affiliate activities including which Advertiser's web sites were visited, which ones had special tangible advertisements created.

Tier one Affiliates 115 may be selling nothing at all. They may just forward potential tier-2 Affiliates, some of whom will contact the system 1 to decide what they want to advertise. The system 1 provides for Real-time tracking of first tier 115 activities including which sites were visited, which ones referred tier-2 affiliates 115 who to the service.

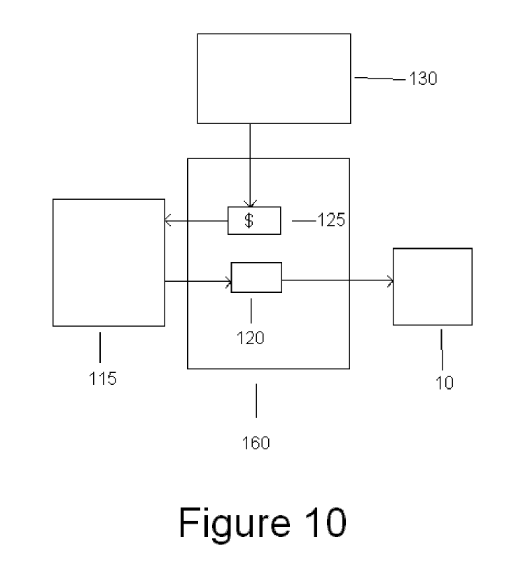

As shown in FIG. 10, the system 1 can use an Offline Affiliate Clearinghouse 160. This is a service at which accounts are settled. An Advertiser makes payment to clearinghouse 160 and the Affiliate 115 receives payment from the clearinghouse 160. Any or all of the participants in the service may pay fees to the clearinghouse 160. Accounts are settled by the clearinghouse 160 and where the Advertisers 130 makes payment and where the Affiliate 115 proposed service to make any web site into a commissioned printable flyer or poster.

When a potential customer completes a sale or information is provided to an Advertiser as a result of Tier-1 or Tier-2 affiliate 115 advertising, advertiser pays a fee to the Clearinghouse and 120 is credited to referring Tier-1 and Tier-2 Affiliates 115.

With a clearinghouse 160, the catalog document includes a hypertextual “referral link” that allows a Tier-1 Affiliate 10 (“customer”) to link to the Advertiser's site 140 and/or the Clearinghouse site 160 and purchase the product 145. As above, when a user 10 selects a referral link, the user's computer transmits unique IDs of the selected product 145 and of the Affiliate 115 to the Advertiser's site 140, allowing the Advertiser 130 to identify the product 145 and the referring Affiliate 115. If the user 10 subsequently purchases the product 145 from the Advertiser's site compensation 125 is automatically credited to an account of the referring Tier-1 and Tier-2 Affiliates 115.

Advantages

The system provides for Real-time tracking of Affiliate activities including which Advertiser's web sites were visited, which ones had special tangible advertisements created. It allows for Third-party contact and processing and for Special offers can be broadcast to Affiliates. It is a centralized Interface for creating custom pages with secure, reliable, scalable infrastructure and multiple formats and offers.

Although the present invention has been described in considerable detail with reference to certain preferred versions thereof, other versions are possible. For example, the web site could use a different or new protocol to communicate or an Intranet could be used. Therefore, the point and scope of the appended claims should not be limited to the description of the preferred versions contained herein.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An internet-based referral system for advertising comprising: having a user connect to a website; having said user select a webpage or electronic file transfer; allowing virtual advertising to be delivered to said user from an Advertiser or his agent, having said affiliate receiving said virtual advertising from an advertiser, having said advertising containing a code to identify the source of said advertising and having an advertiser track said advertising through said code.

2. A system according to claim 1 which includes having said code being a unique identifier code.

3. A system according to claim 1 which includes having said advertising being tangible print media.

4. A system according to claim 2 which includes having said advertising dynamically merged with a code that will identify the advertiser, the affiliate, the item or items for sale, or any combination of these.

5. A system according to claim 1 which includes having said advertisement placed in the tangible world by affiliates.

6. A system according to claim 5 which includes having said affiliates receive compensation based on said advertisement.

7. A system according to claim 5 which includes having said affiliates select from a plurality of products and services to place an advertisement for.

8. A system according to claim 1 which includes having a plurality of affiliate tiers.

9. A system according to claim 8 which includes having said databases contain information about said affiliate and said advertiser.

10. A system according to claim 1 which includes having said user connects to the system through the use of a computer through the Internet.

11. A system according to claim 8 which includes having Tier-1 affiliate and Tier-2 affiliate where Tier-1 affiliates will get a portion of the commissions that are paid to the Tier-2 affiliate the result of sales and leads generated from Tier-2 affiliate's distribution said code.

12. A system according to claim 1 which includes having said advertisement modified automatically by using a computer language on demand, before said tangible print advertisement is printed by the user's computer.

13. A system according to claim 1 which includes having said advertisement including a hyper textual referral link.

14. A system according to claim 13 which includes having said hyper textual referral link or having an Internet “cookie” which transmits a unique code which identifies the affiliate and or Advertiser.

15. A system according to claim 1 which includes having said affiliate receiving compensation for products purchased as a result of the referral.

16. A system according to claim 1 which includes having said system having a clearinghouse function for maintaining said affiliate and advertiser's accounts.

17. An internet-based referral system for advertising comprising: having a user connect to a website; having said user select a URL or webpage; allowing virtual advertising to be delivered to said user from an affiliate, having said affiliate receiving said virtual advertising from an advertiser, having said advertising containing a code to identify the source of said advertising; having an advertiser track said advertising through said code, having said code being a unique identifier code, said advertising dynamically merged with a code that will identify who placed the advertisement; having said advertisement placed by affiliates and having said affiliates receive compensation based on said advertisement.

18. A system according to claim 17 which includes having said affiliates select from a plurality of products and services to place an advertisement for.

19. A system according to claim 17 which includes having said system having a clearinghouse function for maintaining said affiliate and advertiser's accounts.

20. A system according to claim 17 which includes having Tier-1 affiliate and Tier-2 affiliate where Tier-1 affiliates will get a portion of the commissions that are paid to the Tier-2 affiliate the result of sales and leads generated from Tier-2 affiliate's distribution of said code.
